(19) United States
(12) Patent Application Publication
(10) Pub. No.: US 2008/0050076 A1
(43) Pub. Date: Feb. 28, 2008

(54) Low loss photonic waveguide having high index contrast glass layers

(76) Inventors: Ming-Jun Li, Horseheads, NY (US); Daniel Aloysius Nolan, Corning, NY (US); Carlton Maurice Truesdale, Corning, NY (US); James Andrew West, Painted Post, NY (US)

Correspondence Address: CORNING INCORPORATED, SP-TI-3-1, CORNING, NY, 14831, US

(21) Appl. No.: 11/508,505

(22) Filed: Aug. 23, 2006

(51) Int. Cl. G02B 6/032

(52) U.S. Cl. 385/125

(57) ABSTRACT

A low-loss photonic waveguide in the form of a Bragg optical fiber is provided that includes a dielectric core region extending along a waveguide axis that is characterized by a low amount of Rayleigh scattering, and a dielectric confinement region surrounding the dielectric core region that includes alternating layers of different glass compositions having relative refractive index differences that are at least 0.10, and preferably at least 0.30. The core region may be formed from air. The confinement region includes alternating high and low index glass layers wherein the high index layers are substantially pure silica mixed with index raising dopants that form enough % of the high index glass layers by weight to achieve the aforementioned 0.10 difference in indices of refraction, while the low index glass layers may be either substantially pure silica, or silica mixed with index lowering dopants to increase the index contrast between the layers. The use of alternating high and low index glass layers to form the dielectric confinement region allows the Bragg fiber to be usually manufactured on a large scale via conventional fiber optic fabricating techniques with relatively few steps. The resulting fiber is capable of conducting high photonic power levels, and is particularly compatible with short photonic wavelengths, such as ultraviolet light.

### BACKGROUND OF THE INVENTION

1. Field of the Invention

This invention generally relates to photonic crystal waveguides, and is specifically concerned with a Bragg optical fiber waveguides having a dielectric confinement region formed from alternating layers of glass having high-contrast optical indices.

2. Description of the Related Art

Optical waveguides in the form of optical fibers are well known in the prior art, and are used to transmit optical signal information between remote locations. The most common type of optical fiber includes a doped silica core region extending along its central axis surrounded by an undoped silica cladding that has a refractive index less than that of the core region. Optical signals are confined along the core region via total internal reflection (TIR) that results from the contrast in indices of refraction along the core-cladding interface. Almost all such index-guided optical fibers are silica-based in which one or both of the core and cladding are doped with index-raising or lowering dopants to produce the necessary index contrast at the core-cladding interface

While such index-guided optical fibers work reasonably well for their intended purpose, some amount of optical scattering occurs at a microscopic level between the dopant-containing glass composition that forms the light-conducting core, and the pulses of laser light that form the optical signal. Such scattering is known as Rayleigh scattering, and results in greater signal attenuation the farther the distance the optical signal travels through the core. In addition to signal attenuation, cores formed from doped silica also induce distortions in the shape of the optical signal as a result of optical non-linearities. Finally, the solid core of doped silica limits the amount of optical power that can be transmitted through the fiber due to damage of glass from high optical power, the damage being caused by the intrinsic absorption of the bulk glass through the formation of absorbing color centers, or from absorption due to contamination of the end facets.

Bragg optical fibers, which operate as photonic crystal waveguides, are also known in the prior art. Such optical fibers include a core formed of air or some other low Rayleigh-scattering medium surrounded by multiple dielectric layers formed from optical materials having contrasting indices of refraction. The multiple layers form a cylindrical mirror that confines light to the core region over a range of frequencies. Hollow-core Bragg optical fibers offer a number of advantages over conventional, index-guided optical fibers including substantially less signal attenuation per unit distance of fiber due to vastly reduced amounts of Rayleigh scattering, and the ability to conduct substantially higher photonic power levels due to reduced interaction with the material in the hollow core region. Additionally, signal distortions caused by optical non-linearities are much lower than for standard, index-guided optical fibers, while the transmission speed may be up to 50% higher since light travels faster in a gas or vacuum than through a solid. A final advantage is the potential for improved bend performance because Bragg confinement is not as susceptible as total internal reflection is to degradation by bending.

Unfortunately, there are a number of shortcomings associated with known Bragg optical fibers which have thus far prevented them from realizing their full theoretical potential. For example, in order for such a fiber to have a high bandwidth, high index contrast layers are needed to form the dielectric confinement region. In one such Bragg fiber, this was accomplished by forming the high index layers of tellurium having a refractive index of 4.6, and by forming the low index layers of a polymer having a refractive index of 1.59. However, because the tellurium and polymer layers are made by two different processes, this approach many requires fabrication steps and is not suitable for large scale manufacturing. Additionally, the polymer layers are less resistant to heat than glass layers, which renders the resulting fiber incompatible with the transmission of high photonic power levels. In another design of Bragg optical fiber, the high index contrast is accomplished by using layers of air between layers of high-index glass. However, such a design requires the use of very thin (around 45 nm) glass bridges which renders this particular type of Bragg optical fiber difficult to manufacture.

Accordingly, there is a need for a Bragg optical fiber that preserves all of the low-loss, low distortion and high power transmission capabilities in a design that is relatively easy and inexpensive to manufacture. Ideally, such a Bragg optical fiber would have a dielectric confinement region formed from alternating layers of high-contrast glass compositions so that the resulting fiber could be easily manufactured by way of conventional optical fiber fabricating techniques. Additionally, it would be desirable if the glass composition material were relatively common and inexpensive to reduce the cost of fabrication. Finally, the index contrast between the layers forming the confinement region should be at least on the order of 0.10 so that a high bandwidth capability is achieved.

### SUMMARY OF THE INVENTION

Generally speaking, the invention is a low loss photonic crystal waveguide comprising a Bragg fiber waveguide that overcomes the aforementioned short comings associated with the prior art. To this end, the Bragg fiber waveguide of the invention includes a dielectric core region extending along a waveguide axis that is characterized by very low Rayleigh scattering, and a dielectric confinement region surrounding the dielectric core region that includes alternating layers of different glass compositions having relative refractive indices that differ by at least about 0.10, and preferably by about 0.10 to 1.00. Preferably, the dielectric core region is devoid of solid material and is filled with a gas such as air in order to minimize Rayleigh scattering. Alternatively, the dielectric core region may be formed from a vacuum, or a low loss solid material such as pure silica without dopants. However, air is preferred due to the very low scattering losses and the ease of manufacture.

The dielectric confinement region includes alternating high and low index glass layers, wherein the high index layers are preferably substantially pure silica mixed with index raising dopants that form at least 10% of the high index glass layers by weight. The low index glass layers may be formed from either substantially pure silica without any dopants, or substantially pure silica mixed with index lowering dopants in order to increase the contrast of the indices of refraction between the alternating glass layers. When an index lowering dopant is used in the low index layers, the proportion mixed with the silica is preferably chosen such that the viscosity of the molten glass forming the low index layers is substantially the same as the viscosity of the glass forming the high index layers in order to reduce thermal stresses between the layers during manufacturing.

The high index layers within the dielectric confinement region may include index raising dopants such as TiO₂, GeO₂, Al₂O₃, ZrO₂ and Nb₂O₅. The low index layers may include index lowering dopants such as fluorine and B₂O₃. Preferably, the index raising or index lowering dopants added to the silica that forms both the high and the low index layers constitutes between about 10% and 30% of the resulting doped glass layers by weight, and the dielectric confinement region includes at least three or more pairs of alternating layers of high and low index glass.

Because the Bragg fiber in the invention may be formed entirely of glass compositions, it may be easily manufactured by conventional optical fiber fabricating techniques on a large scale, and with relatively few steps. The resulting fiber is mechanically and thermally robust and requires no special considerations for handling or installation. Finally, the resulting fibers are particularly compatible with ultraviolet wavelengths which in turn increases the bandwidth capacity of the resulting fiber.

### BRIEF DESCRIPTION OF THE DRAWINGS

FIG. 1 is an enlarged, cross sectional view of the Bragg optical fiber waveguide of the invention;

FIG. 2 is a family of curves illustrating changes in the refractive index of glass compositions containing different proportions of germanium dioxide (GeO₂) for different wavelengths of light;

FIG. 3 illustrates the first step of the preferred method for manufacturing the Bragg optical fiber of the invention wherein a glass soot blank is formed over a glass tube;

FIG. 4 illustrates the second step of the preferred method of manufacture, wherein the soot layers of different glass compositions that were vapor deposited over the glass tube are fused and consolidated in a furnace to form a glass blank;

FIG. 5 illustrates the next step of the preferred method of manufacture, wherein the glass tube is etched out of the glass blank to form a hollow core region;

FIG. 6 illustrates the fourth step of the preferred method of manufacture, wherein the glass blank produced in the previous step is reheated and drawn down into a narrower blank;

FIG. 7 illustrates the next step of the method, wherein the additional layers of alternating high and low index compositions vapor are deposited on the drawn-down glass blank produced in the previous step to form a second glass soot blank; and

FIG. 8 illustrates the final steps of the invention, wherein the resulting second, glass soot blank is heated in the furnace in order to fuse and consolidate the soot layers of different high and low index glass compositions around its exterior.

### DETAILED DESCRIPTION OF THE PREFERRED EMBODIMENT

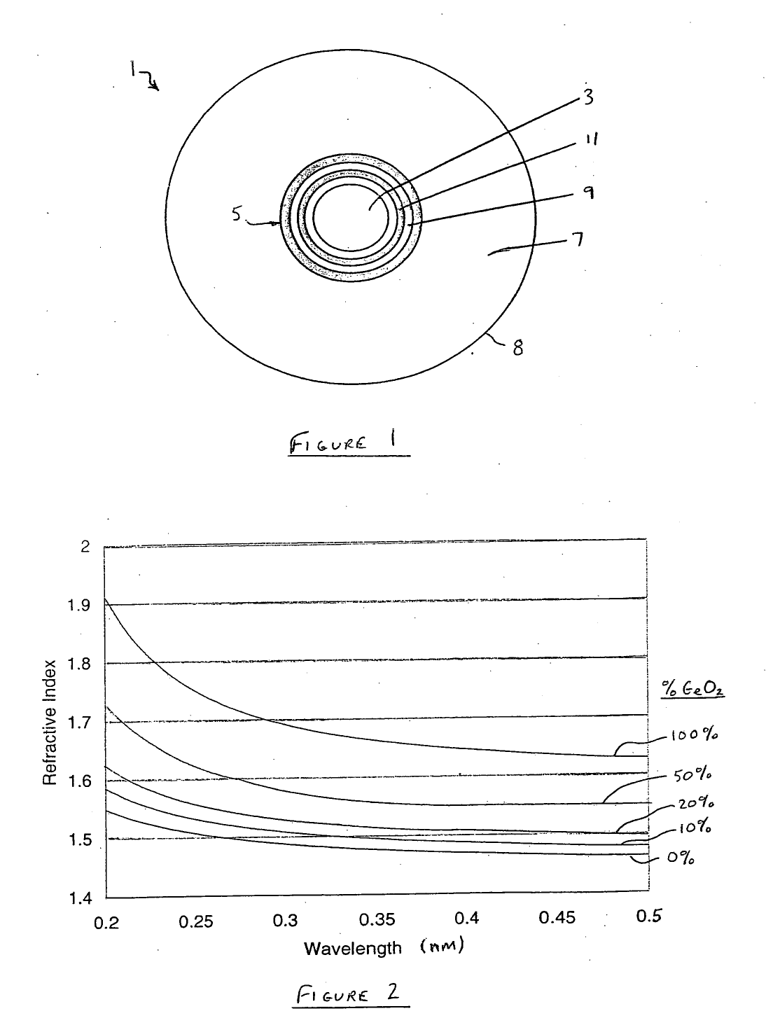

With reference now to FIG. 1, the photonic Bragg optical fiber waveguide 1 that forms the photonic crystal waveguide of the invention generally comprises a dielectric core region 3 that extends along the central access of the fiber 1, and a dielectric confinement region 5 that surrounds the core region 3. The dielectric core region may be between about 100 nm and 500 microns (for example, 250 nm, 500 nm, or 100 μm) in diameter, while the dielectric confinement region may be between about 500 nm and 100 microns in thickness (for example, 250 nm, 500 nm, 10 μm, or 50 μm). An outer silica cladding 7 in turn surrounds the dielectric confinement region 5 and defines the outer surface 8 of the fiber 1 as shown. The cladding may be between 10 microns to 1000 microns in thickness, and more preferably 50 to 200 microns thick.

The dielectric core region 3 is preferably air for its very low optical attenuation properties, and for its relative ease of manufacture. However, the dielectric core region 3 may also be a vacuum, or filled with other low attenuation gases other than air. Finally, it is also possible for the dielectric core region 3 to include a solid material having very low Rayleigh scattering, such as pure silica. However, the use of solid materials in the dielectric core region 3 is not generally preferred due to the lower index contrast between most solid materials, and the first layer of the dielectric confinement region 5.

The dielectric confinement region 5 is formed from a plurality of pairs of high index layers 9, and low index layers 11. While only two pairs of such layers are illustrated in FIG. 1, the dielectric confinement region 5 of the preferred embodiment will have at least 4 and preferably 5 such pairs, and more preferably between 10 and 100 such pairs, depending upon the desired level of signal attenuation per unit length, and the contrast in the index of refraction between the high index and low index layers 9 and 11. If very low attenuation per unit length is desired, more pairs of high and low index layers 9 and 11 will be required. However, the greater the difference in the index of refraction between the layers 9 and 11, the fewer pairs will be needed at the same level of signal attenuation.

The high index layers 9 are preferably formed from glass compositions comprising silica and an index raising dopant, for example, oxides of Ti, Nb, Al, Zr or Ge, such as germanium dioxide (GeO₂), aluminum dioxide (Al₂O₃), zirconium dioxide (ZrO₂), titanium dioxide (TiO₂) and niobium pentoxide (Nb₂O₅). It is within the scope of this invention to form the high index layers 9 completely from a glass comprised entirely of a dopant compound Accordingly, the term “glass composition”, as used in this application, includes glasses made entirely from dopant compounds and does not require the presence of silica. However, the presence of at least some silica is preferred in order to provide manageable amounts of thermal stresses between the high and low index layers 9, 11 caused by thermal differential expansion. Hence, glass compositions comprising at least 17% by weight are preferred. Of course, glass compositions comprising substantially more silica may be used, but in all cases, a sufficient amount of index raising dopant should be present to create at least about a 0.10 difference and more preferably 0.3 difference in the index of refraction (relative refractive index) between the high index layers 9, and the low index layers 11 (i.e, n_{H}-n_{L}>0.1, preferably >0.3, where n_{L} and n_{H} correspond to refractive indices of the low and high refractive index layers 9 and 11). The table below displays the refractive index n_{D} for a light having a wavelength of 589.3 nm for different glass compositions formed substantially from the index raising dopant listed on the left side:

| SiO₂ with Dopants: | n_{D} | Difference to n_{D} of SiO₂ |
|---|---|---|
| GeO₂ | 1.656 | 0.190 |
| Al₂O₃ | 1.680 | 0.214 |
| ZrO₂ | 1.910 | 0.444 |
| TiO₂ | 2.340 | 0.874 |
| Nb₂O₅ | 2.2 | 1.484 |

Where n_{D} is the refractive index of a layer measured at the 56 drum D spectral line (λ=589.3 nm). The above glass compositions are particularly suitable for Bragg fibers in the ultraviolet region because the refractive index difference between the high and low index layers 9 and 11 can be much higher. FIG. 2 illustrates how the index of refraction increases in GeO₂ doped glass in the short wavelength region. For glass formed of pure GeO₂ the index difference relative to pure silica becomes 0.363 (at 0.2 μm wavelength), which is much higher than the 0.190 difference at 589.3 nm.

The low index layers 11 may be either pure silica glass, or silica glass doped with an index decreasing dopant such as fluorine, or boron oxide (B₂O₃). The advantage of using an index decreasing dopant is two-fold. First, it increases further the index contrast between the high and low index layers 9, 11. Second, it offers the flexibility to match the viscosity of the high index glass layer during the manufacture of the fiber if the dopant level is properly selected. By selecting a level of index decreasing dopant which matches the viscosity of below index layers 11 to the high index layers 9 during manufacture, the thermal stresses generated within the resulting optical fiber during manufacture can be significantly reduced.

The preferred design for a Bragg fiber includes pairs of high and low index layers, 9 and 11 respectively, in which each pair preferably has an optical path length of about 0.5λ (n_{L}d_{L}+n_{H}d_{H}≈0.5), where λ is the signal wavelength, n_{L} and d_{H} correspond to refractive indices of the low and high refractive index layers 9 and 11, and d_{L} and d_{H} correspond to thickness of the low and high refractive index layers 9 and 11 respectively. Each layer of the pair may have a thickness that corresponds to an optical path length (physical distance times the refractive index) of approximately one quarter of the wavelength of light at the design wavelength. For example, for a fiber made of layers of pure silica and pure germania operating at a wavelength of 0.5893 microns, the resulting physical thicknesses would be d_{H}=89 nm and d_{L}=100 nm for the high and low index layers respectively. Alternative exemplary designs relax the strict requirement on quarter-wave thickness for the individual layers and require that bilayer optical path n_{H}d_{H}+n_{L}d_{L} be one half of a wavelength. The quarter wave approximation is sufficient for fibers in which the core diameter is much larger than the layer thicknesses. However, as the circular core is made smaller (as might be required for single-mode operation) the bilayer thickness should correspond to the zeroes of the Bessel functions. We also consider noncircular cores (example, elliptical) in which the deviation from the quarter-wave approximation will be more complex and will depend on geometry.

While most of the cladding layers in the dielectric confinement region 5 will follow the prescription outlined in the previous discussion, the inner-most layer adjacent to the core may be designed with additional flexibility. This first layer may be high or low index (FIG. 1 shows an example of a high-index inner layer) and additionally, the thickness of this layer may be chosen differently from the other layers in the dielectric confinement region 5. Such flexibility can allow improved dispersion properties or reduced attenuation due to improved optical confinement.

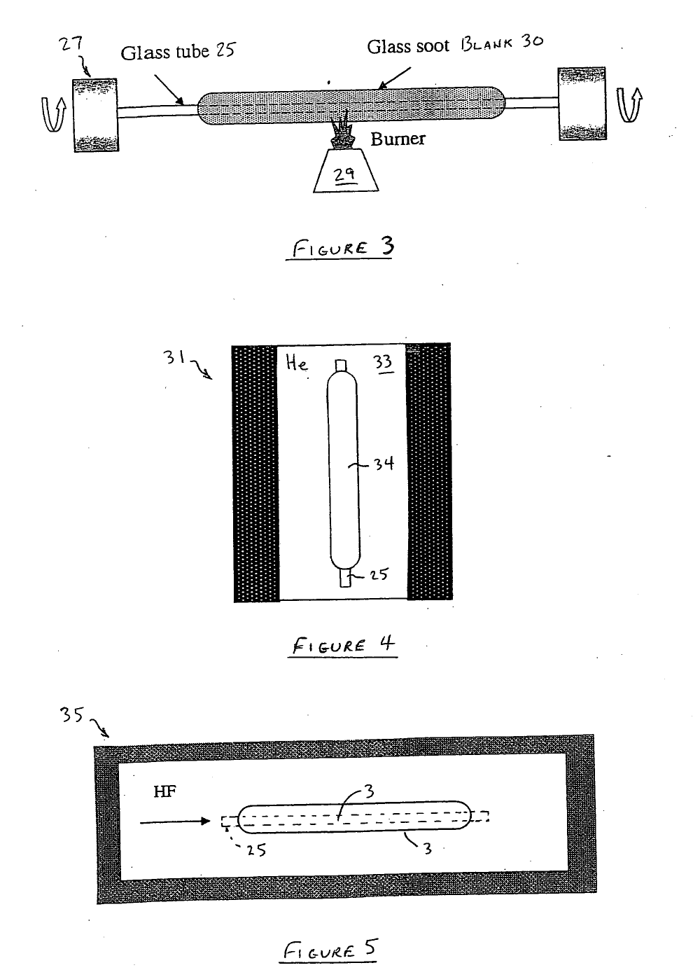

The preferred method of manufacturing the Bragg optical fiber 1 of the invention is illustrated in FIGS. 3-8. FIG. 3 illustrates the first step of this method, wherein a glass tube 25 is supported between a rotating mechanism 27 and heated by a burner 29 while glass compositions that will ultimately form the high and low index layers 9 and 11 are deposited on the glass tube 25 via the well known technique of outside vapor deposition (OVD), although such layers may also be deposited by modified chemical vapor deposition (MCVD), or plasma chemical vapor deposition (PCVD). The diameter of the glass tube 25 is selected according to the desired fiber core diameter and thickness of the dielectric confinement region 5, and outer cladding 7. The glasses forming the high and low index layers 9, 11 of the dielectric confinement region are deposited in alternating fashion to create at least some of the necessary number of pairs of high and low index layers 9, 11 for the dielectric confinement region 5 having sufficient reflectivity to avoid unwanted signal attenuation through optical leakage. The end result of this first step is a glass soot blank 30 which comprises alternating particulate layers of the different glass compositions forming the high and low index layers 9 and 11. Such a glass soot blank may have, for example, an outer diameter of about 7 mm. Preferably the number of layers is at least 6, more preferably at least 8 and most preferably 10 to 100.

FIG. 4 illustrates the next step of the preferred method, wherein the glass soot blank 30 is disposed within a furnace 31 having an interior 33 filled with helium gas. The temperature of the interior 33 is raised to a point which fuses the particulate layers of the glass soot blank 30 into concentric overlapping layers of glass. The presence of helium in the interior 33 avoids the formation of bubbles or voids within the high and low index layers 9, 11 since molecular helium is sufficiently small to diffuse through the glass fibers. The end result of the second step of the method is a consolidated blank 34.

FIG. 5 illustrates the third step of the method, wherein the glass tube 25 forming the core of the consolidated blank 34 is removed. This is achieved by disposing the consolidated blank 37 in an etching chamber 35, and exposing the glass tube 25 to a flow of hydrofluoric gas. The removal of the glass tube 25 defines an air filled core region 3.

FIG. 6 illustrates the fourth step of the method, wherein the consolidated blank is moved from the etching chamber 35 after the removal of the glass tube 25, and disposed in the interior of a draw-down furnace 38, which provides sufficient heat to the blank 37 to render it molten. The molten glass blank 37 is pulled through an orifice at the bottom of the draw-down furnace 38 to create a redrawn glass-drawn blank 39 which is substantially smaller in diameter than the glass blank 37. For example, if the glass consolidated blank 37 were 30 mm in diameter, the redrawn glass blank 39 would typically be between 6 and 10 mm in diameter.

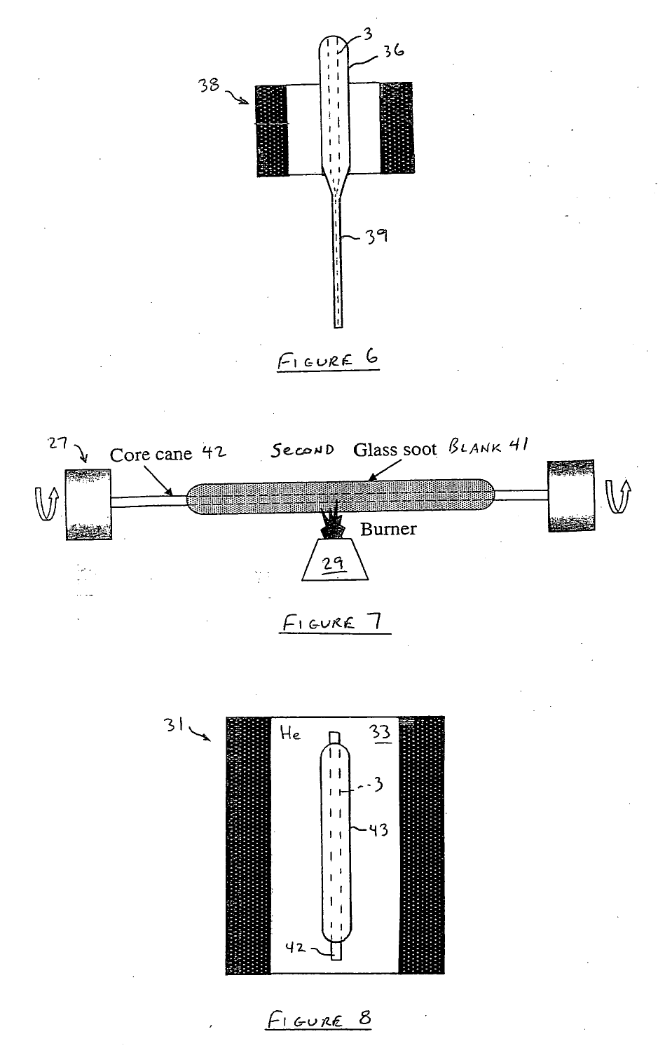

The redrawn glass blank 39 is then removed from the drawing furnace 38, mounted on a rotating mechanism 27 as illustrated in FIG. 7, and the re-drawn glass blank 39 is re-exposed to the previously described OVD process so that silica cladding may be formed around its outer diameter. The hollowed-out core region 3 of the blank is preserved during this step.

FIG. 8 illustrates the last steps of the method of the invention, wherein the glass soot blank 41 produced in the previous step is again disposed when a furnace 31 having an interior 33 filled with helium, and heated in order to consolidate the cladding layer(s). The core cane 42 is then removed, and the resulting second consolidated glass blank 43 is then drawn into fiber using a conventional fiber draw tower.

For example, the typical laydown of many alternating TiO₂-doped SiO₂ and SiO₂ soot layers are carried out as follows. The SiCl₄ vapor is provided to the burner by a reactant delivery system of the type described, for example, in U.S. Pat. No. 4,314,837 to Blankenship. The TiCl₄ vapor is provided to the burner by a flash vaporization system as described, for example, in U.S. Pat. No. 5,078,092 to Antos et al. To make the alternating TiO₂-doped SiO₂ layers the individual vapors are entrained in a carrier gas stream, mixed together prior to combustion and then passed through a burner flame, usually a natural gas/oxygen mixture which frequently contains excess oxygen. An alternative method uses octamethylcyclotetrasiloxane (an organometallic silicon precursor) vapor provided to the burner uses a flash vaporization system as described, for example, in U.S. Pat. No. 5,043,002 to Dobbins and McClay and titanium isopropoxide (an organometallic titanium precursor) vapor that is provided to the burner by a flash vaporization system as described, for example, in U.S. Pat. No. 5,154,744 to Blackwell and Truesdale. The concentration of the TiO₂-doped SiO₂ layers are at least 15 wt % TiO₂ and less than 99 wt % TiO₂.

The preform can be made using MCVD or PCVD processes as well. The difference is that, in a MCVD or PCVD process, the deposition and consolidation of cladding layers happens inside the starting glass tube. Therefore no chemical etching step is necessary for removing the tube. After the preform is made, it is drawn into fiber using a conventional fiber draw tower.

While both the fiber and its method of manufacture have been described with reference to the foregoing specific examples, many modifications and variations of both fiber and the method have become apparent to those having skill in the art. For example, while the high and low index layers have been described with respect to specific index raising and lowering dopants, any glass composition that achieves such index raising or lowering may be used in the context of this invention. Additionally, while the method of the invention is described with respect to only a single iteration of the vapor deposition step, three or more such vapor deposition steps may be used to create 100 or more pairs of electric confinement region with 100 or more pairs of high and low index layers. Finally, while the dielectric core region has been illustrated as being a single opening filled with air, the core region may include any material (or even a vacuum) having substantially smaller Rayleigh scattering than the doped silica typically used in conventional, index-guided optical fibers. All such variations and modifications are encompassed within the scope of this invention, which is limited only by the appended claims, and their equivalents.

I/We claim:

1. A photonic Bragg fiber waveguide, comprising
a dielectric core region extending along a waveguide axis; and
a dielectric confinement region surrounding the dielectric core region and including alternating layers of different glass compositions having relative refractive indices that differ by at least about 0.10, wherein said dielectric confinement region includes three or more pairs of high and low index glass layers.

2. A photonic Bragg fiber waveguide as defined in claim 1, wherein said relative refractive index difference of said alternating layers of different glass compositions is between about 0.10 to 1.00.

3. A photonic Bragg fiber waveguide as defined in claim 1, wherein said relative refractive index difference of said alternating layers of different glass compositions is at least about 0.30.

4. A photonic Bragg photonic waveguide as defined in claim 1, wherein said dielectric core region is devoid of solid material.

5. A photonic Bragg fiber waveguide as defined in claim 4, wherein said dielectric core region is filled with a gas.

6. A photonic Bragg fiber waveguide as defined in claim 5, wherein said dielectric core region is filled with air.

7. A photonic Bragg fiber waveguide as defined in claim 1, further comprising an outer glass cladding surrounding the dielectric confinement region.

8. A photonic Bragg fiber waveguide as defined in claim 1, wherein said dielectric confinement region includes alternating high and low index glass layers.

9. A photonic Bragg fiber waveguide as defined in claim 8, wherein said high index layers are substantially pure silica mixed with index raising dopants that form at least about 10% of the high index glass layers by weight, and said low index glass layers are substantially pure silica.

10. A photonic Bragg fiber waveguide as defined in claim 9, wherein said high index layers are substantially pure silica mixed with index raising dopants, and low index glass layers are substantially pure silica mixed with index lowering dopants to increase the difference in the relative refractive index between the high and low index layers.

11. A photonic Bragg fiber waveguide as defined in claim 10, wherein said index lowering dopants are selected such that the viscosity of the glass forming the low index layers is substantially the same as the viscosity of the glass forming the high index layers during manufacture to reduce thermal stresses between said layers.

12. A photonic Bragg fiber waveguide as defined in claim 8, wherein said index raising dopants include at least one of the following: Ti, Nb, Al, Zr and Ge.

13. A photonic Bragg fiber waveguide as defined in claim 10, wherein said index lowering dopants include fluorine and B₂O₃.

14. A photonic Bragg fiber waveguide as defined in claim 1, wherein said dielectric confinement region includes five or more pairs of high and low refractive index glass layers.

15. A photonic Bragg fiber waveguide as defined in claim 7, wherein the thickness of said cladding is between about 10 microns to 100 microns.

16. A photonic Bragg fiber waveguide as defined in claim 9, wherein said index raising dopants form at least about 20% of the high index glass layers by weight.

17. A photonic crystal fiber waveguide, comprising
a dielectric core region devoid of solid material and extending along a waveguide axis; and
a dielectric confinement region surrounding the dielectric core region and consisting of alternating layers of different glass compositions having high and low relative refractive indices that differ by at least about 0.10, wherein said layers having high refractive indices are substantially pure silica mixed with index raising dopants, and said layers having low refractive indices include substantially pure silica.

18. A photonic crystal fiber waveguide, as defined in claim 17, wherein the relative refractive index differences of said alternating layers of different glass compositions are between 0.10 to 1.00.

19. A photonic crystal fiber waveguide as defined in claim 18, wherein said dopants form at least about 10% of the high index glass layers by weight and wherein the relative refractive index differences of said alternating layers are at least 0.30.

20. A photonic crystal fiber waveguide defined in claim 19, wherein said low index glass layers are substantially pure silica that includes index lowering dopants to increase the difference in the refractive indices between the high and low index layers; and wherein said index lowering dopants are selected such that the viscosity of the glass forming the low index layers is substantially the same as the viscosity of the glass forming the high index layers during manufacture to reduce thermal stresses between said layers.
